(19) United States
(12) Patent Application Publication
(10) Pub. No.: US 2016/0037505 A1
(43) Pub. Date: Feb. 4, 2016

(54) DIGITAL RADIO SYSTEM

(71) Applicant: Purdue Research Foundation, West Lafayette, IN (US)

(72) Inventor: Todor V. Cooklev, Fort Wayne, IN (US)

(21) Appl. No.: 14/815,639

(22) Filed: Jul. 31, 2015

Related U.S. Application Data
(60) Provisional application No. 62/031,807, filed on Jul. 31, 2014.

(51) Int. Cl. H04W 72/04; H04W 84/20; H04W 8/20

(52) U.S. Cl. CPC H04W 72/0406; H04W 8/20; H04W 84/20

(57) ABSTRACT

A thin radio client can include a radio frequency (RF) subsystem having a transmitter and/or a receiver. An interface can transmit and receive packets. The interface can reconfigure the transmitter in response to a received transmitter-control packet, reconfigure the receiver in response to a received receiver-control packet, or transmit a context packet including both data of a state of the transmitter and data of a state of the receiver. A digital back end can include an interface to exchange packets with an RF device. At least some of the received packets can specify capabilities of the RF device or state of the RF device. The back end can determine a control packet based on received packet(s) and on a policy governing behavior of the RF device, and transmit the control packet to the RF device. A method of operating a distributed radio system is described.

### CROSS-REFERENCE TO RELATED APPLICATIONS

This application is a nonprovisional application of, and claims priority to and the benefit of, U.S. Provisional Patent Application Ser. No. 62/031,807, filed Jul. 31, 2014 and entitled “A Distributed Cloud-Based Radio Architecture and System Integrating Spectrum Monitoring and Spectrum Management,” the entirety of which is incorporated herein by reference.

### TECHNICAL FIELD

The present disclosure generally relates to control and operation of radio systems, and in some examples to spectrum monitoring and spectrum management.

### BACKGROUND

Many wireless communication systems have been fielded, and many more are under development. The radio frequency (RF) spectrum has growing economic value to consumers, businesses, and governments worldwide. This highly valued commodity has generated such an ever increasing demand for wireless bandwidth so that the existing primary method of spectrum management, spectrum allocation, is becoming increasingly inadequate. In general, the RF spectrum has three dimensions—time, frequency, and location. While current spectrum management has utilized nearly the entire frequency dimension, there is significant unexploited potential along the other dimensions. Spectrum surveys have shown that much of the licensed spectrum is idle at any given time. Consequently, responses to requests for additional bandwidth increasingly involve sharing rather than exclusive allocation. The concept of spectrum sharing is simple: If one system does not require bandwidth at specific times, that bandwidth can be used by secondary systems during those times, provided that the secondary systems do not cause unacceptable interference.

### BRIEF DESCRIPTION OF THE DRAWINGS

Objects, features, and advantages of various aspects will become more apparent when taken in conjunction with the following description and drawings wherein identical reference numerals have been used, where possible, to designate identical features that are common to the figures. The attached drawings are for purposes of illustration and are not necessarily to scale.

FIG. 1 shows an example cloud-based radio network.

FIG. 2 shows an example radio and related components.

FIG. 3 shows an example RF front end and RF-digital interface components.

FIG. 4 shows an example transmitter and interface packets.

FIG. 5 shows an example receiver and related components.

FIG. 6 shows an example wireless relay and interface packets.

FIG. 7 shows an example software-defined radio cloud system and interface packets.

FIG. 8 shows a flowchart of an example method for operating a distributed radio system.

FIG. 9 shows an example data-processing system useful with various aspects.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Various aspects relate to systems and methods for spectrum monitoring using a distributed network of sensors allowing spectrum management to be integrated. Various aspects relate to integrating spectrum management and monitoring on a large scale. While spectrum sharing is very desirable, it will produce a variety of interference scenarios and will require accurate real time spectrum usage data.

Existing spectrum usage data is largely based on one-time surveys that have been conducted in many locations around the world. The technical parameters of spectrum sensors are generally well understood. Though the goals and technical parameters of these surveys differed, they each lasted for a relatively short period of time, typically used a single spectrum analyzer connected to a laptop computer, and were performed at one site or at a single site at a time. Some prior schemes are based on spectrum analyzers connected to laptop computers. Spectrum analyzers are designed as powerful pieces of lab equipment with a human operator interpreting signals in real-time. It would be inefficient to build a large-scale system for permanent spectrum monitoring simply by extending prior monitoring-campaign schemes. The reason is that at present it is not possible to integrate data obtained from different spectrum sensors, with different resolution, etc. A large-scale spectrum monitoring program was contemplated by the Federal Communications Commission (FCC) at the beginning of 1970s, but subsequently abandoned. More recently, the National Telecommunications and Information Agency (NTIA), which is responsible for government-wide spectrum management and which also assigns spectrum to federal agencies, has been criticized that it merely aggregates the spectrum needs of the different government agencies and is being incapable to ensure that spectrum is being used efficiently. Additionally, the Government Accountability Office (GAO) has also found that the accuracy of agency-reported data could not be guaranteed.

In 2013 the President issued a Memorandum directing NTIA to design and conduct a pilot program to monitor spectrum usage in real-time in select communities around the country. One of the goals of the monitoring is to identify opportunities for spectrum sharing, not only among government agencies, but also between government and non-government users. The NTIA asked for input what should be the parameters of such a system, such as monitored frequency band(s), resolution bandwidth, sampling rate, dwell time, antennas, geographic locations, etc. and several companies responded.

The responses reveal emerging consensus regarding several aspects. Spectrum monitoring between 30 MHz and at least 3 GHz, preferably 6 GHz, is needed. It is possible that in the future monitoring is extended to other frequency bands. The industry generally believes that spectrum monitoring should capture and store in-phase and quadrature (IQ) components at baseband or IF output. The IQ data should then be processed using fast Fourier transforms (FFTs) to obtain power spectral density. Other specialized analysis can also be performed on the IQ samples. Another aspect where consensus is emerging is that monitoring should start with a priori information provided by an accurate database of systems that are known to be operational. This database can include the technical parameters that are relevant for their term of authorization, such as frequency bands, effective radiated power, etc. One purpose of the monitoring is to confirm that the known systems operate as authorized, or to provide evidence that they are not. Furthermore, monitoring can be used to identify transmitters that are not included in the database and are therefore presumably unlicensed. Another purpose of spectrum monitoring is to help determine how much of the spectrum is being used by systems that have been allocated parts of the spectrum and identify opportunities for spectrum sharing. Monitoring can also be useful to identify interference issues among wireless systems. To achieve all of these goals monitoring has to be permanent; one-time, single-site surveys are no longer adequate.

There is thus an unmet need for a novel distributed system capable of sensing usage of the available spectrum between two or more frequency limits.

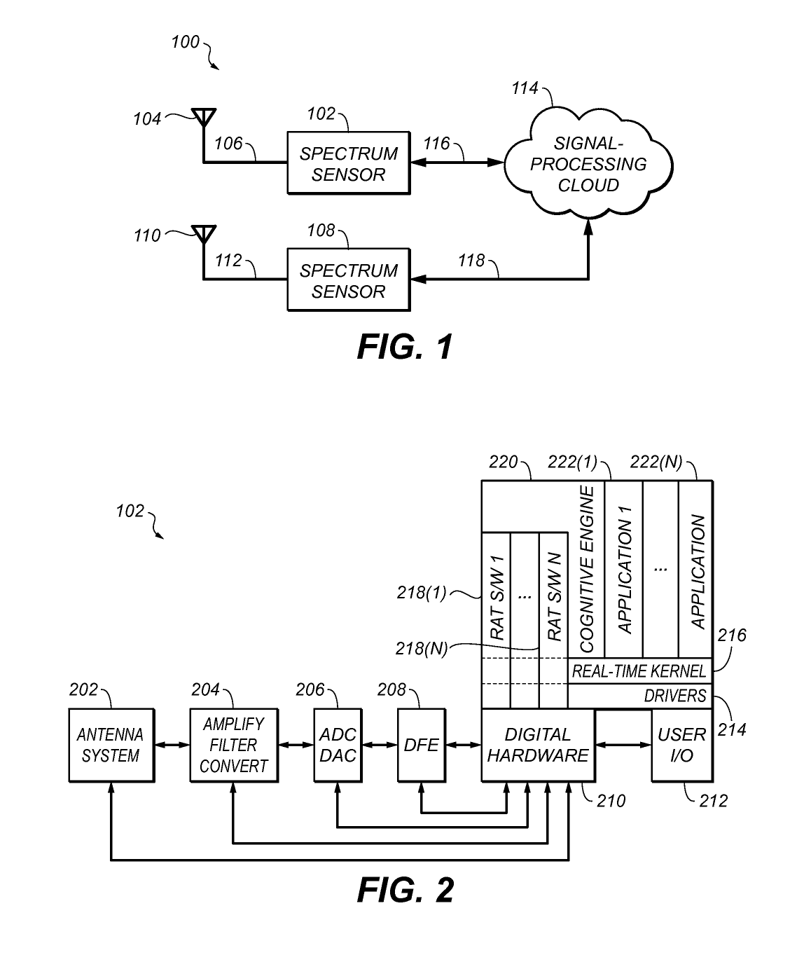

FIG. 1 shows an example cloud-based network and system of spectrum sensors useful, e.g., for spectrum monitoring. The term “cloud” is used herein to indicate available servers and their computation power on the Internet or some other network. Various examples permit ontology descriptions to be used for both spectrum management and monitoring. These ontology descriptions allow semantic techniques such as queries, responses, and reasoning to be used. Example systems disclosed herein include multiple simple, inexpensive spectrum sensors.

Wireless signals are centered at a certain radio frequency (RF). Signal-processing operations, e.g., synchronization and modulation, can be implemented on baseband signals centered at substantially zero frequency or having positive frequency components extending upwards from substantially zero frequency. Therefore, receivers can down-convert from RF to baseband. Transmitters can perform the opposite process of up-conversion. The RF front end, located between the antenna and the digital subsystem, can perform the tasks of down-conversion and up-conversion and can also perform filtering for frequency band selection and amplification.

Various aspects include an RF-digital interface that permits the RF front end and the digital hardware to be seamlessly replaced independently of each other. Various example interfaces herein process a stream of data and metadata (context and control) packets. The interface describes the RF front end and can serve as a hardware abstraction language for the RF front end. The metadata packets can be described using a simple ontology, such as RDF (described below), and exchanged among different cognitive radio platforms. Various terms used in the present application are given in Table 1.

TABLE 1

| Term | Definition |
|---|---|
| Baseband | digitally modulated signal that is low-pass in nature (that is, |
| | not up-converted onto an RF carrier) |
| Interpolation | increasing the sampling frequency |
| Decimation | decreasing the sampling frequency |
| IF | intermediate frequency |
| Down- | the process of moving a signal's spectrum content from |
| conversion | RF to zero frequency (or to IF) |
| Up- | the process of moving a signal's spectrum content |
| conversion | from zero to RF (or to IF) |
| Waveform | software that implements a radio-access technology |
| software | a general mechanism to describe objects in a certain domain |
| Ontology | and the relationships between them |
| Metadata | data that helps interpret signals (data about data) |

Between, e.g., 30 MHz and 6 GHz there are numerous wireless systems with different bandwidths, modulation formats, multiple-access techniques, or output power levels. There are certain bands where real-time or near real-time performance is required, for example bands used by public-safety operations. Spectrum use varies widely with location and therefore, different monitoring systems may be needed in urban, suburban, rural, and remote areas. For example, modern civilian, public-safety, and military wireless networks are highly heterogeneous. It is desirable for new radios, services, and applications to be readily incorporated, without significant changes elsewhere in the network. Various aspects relate to a language that can be used to describe both the capabilities of RF components and their current operational status.

FIG. 1 shows a cloud-based spectrum monitoring system 100 according to various aspects. Spectrum sensor 102 is connected to antenna 104 via link 106, e.g., an RF feed line. Spectrum sensor 108 is connected to antenna 110 via link 112, e.g., an RF feed line. Spectrum sensor 102 is connected to signal-processing cloud 114 via link 116, e.g., a digital link as described herein. Spectrum sensor 108 is connected to cloud 114 via link 118, e.g., a digital link as described herein.

In some examples, spectrum sensors 102, 108 have a bidirectional interface with cloud 114. In some examples, spectrum sensors 102, 108 include analog as well as digital hardware. In an example spectrum monitoring system 100, the sensors 102, 108 can offer at least a sensing service to cloud 114. Other services such as modulation identification, and, in some cases, complete demodulation of the signal, can also be provided. The cloud 114 can also offer services to the spectrum sensors 102, 108, thin clients or third parties.

The cloud 114 can offer the use of digital hardware using the infrastructure as a service (IaaS) model. Higher levels of service can also be offered, such as “platform as a service” (PaaS), where in addition to digital hardware, the cloud offers the use of system-level software, and “spectrum monitoring software as a service”, where the use of a hardware and software solution that implements spectrum monitoring is offered as a service. The monitoring software can be implemented as a collection of interacting entities each fulfilling a specific role. In some examples, cloud 114 offers “radio software as a service”, where the software that implements a RAT together with the cognitive engine (CE) is offered as a service. In this model users are given access to radio software on an “on-demand” basis. This eliminates the need to install and run the radio software on the radio platform, which simplifies maintenance and support.

The amount of data produced by spectrum monitoring can be quite large. The amount of data produced is B=Fₛ×N_{b}×T bits, where Fₛ is the sampling frequency, N_{b} is number of bits per sample, e.g., 32 bits per sample including 16 bits per sample of the in-phase (I) component and 16 bits per sample of the quadrature (Q) component, and T is the recording time. For example, to continuously monitor the band 30 MHz-6 GHz, assuming a practical sampling frequency of 15 GHz or 7.5 GHz in quadrature, over 2,500 Terabytes per day would be generated by just a single spectrum sensor. Prior systems (1) do not monitor the entire band continuously, and (2) reduce the IQ data to only certain time intervals in a 24-hour period, in order generate much less data, e.g., on the order of several GB/hour.

The interface to the cloud 114, in some examples, operates using abstract descriptions of the technical parameters of the sensors 102, 108. This permits, e.g., replacing one or more of the sensors 102, 108 independently of other(s) of the sensors 102, 108. In some examples, packet-based formats such as the VITA 49 standard provide abstractions of RF front-ends. VITA 49 defines two main types of packets: data (e.g., IQ samples) and metadata (data about data, e.g., context data). VITA 49 packets can be carried over links 116, 118. A packet format can be independent of the specific technique to carry these packets. The actual interface to the cloud 114 via links 116, 118 may be, e.g., Ethernet or wireless. A metadata packet can include one or more of the RF center frequency, bandwidth, sample rate, timestamp, location, or calibration information of one of the sensors 102, 108, and can be generated every time one or more of these parameters changes. The timestamp can reflect all delays prior to digitization. Each signal packet stream (also referred to as a “data packet stream”) can be paired with its corresponding metadata packet stream using a common stream identifier. The metadata can provide an abstract description of a spectrum sensor 102, 108 and can permit a received RF signal impinging on antenna 104, 110 to be, e.g., described exactly or later reconstructed. Furthermore, Time Difference of Arrival (TDOA) localization can be performed using the packet streams from multiple sensors 102, 108.

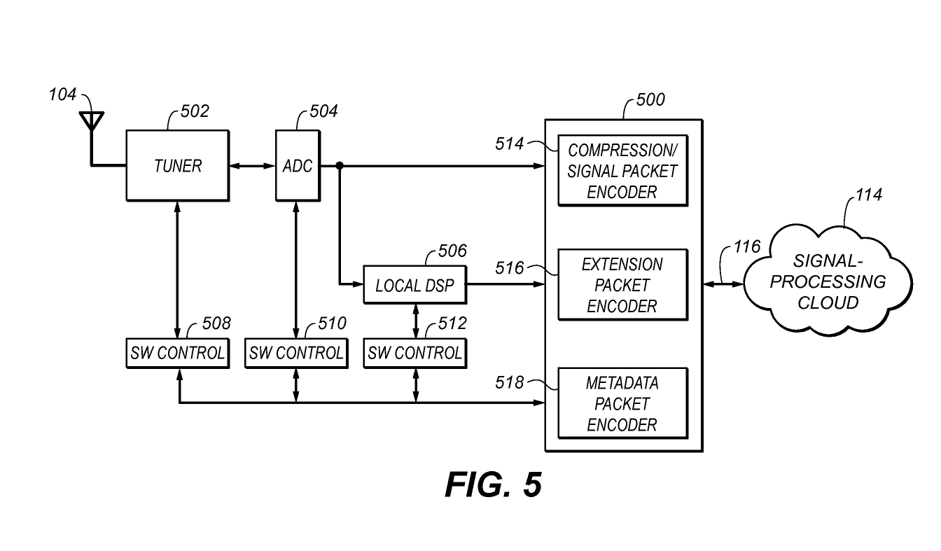

Since monitoring generates enormous amount of IQ data, various aspects include compression on the IQ samples. In some examples, lossless compression ratios of about 1.5 and lossy compression ratios of up to 4 lead to a small increase on the bit error rate; furthermore the performance degradation is gradual. Monitoring typically does not involve demodulation of the wireless signals and therefore, compression ratios can be much higher. FIG. 5, discussed below, illustrates a spectrum sensor 102, 108 that can compress the IQ samples before transmitting a signal packet (also referred to as a “data packet”) to the cloud 114. If the sensors 102, 108 perform more computationally intensive steps such as fast Fourier transforms (FFTs) or fast feature identification, the results can be transmitted as extension packets, also as discussed below with reference to FIG. 5.

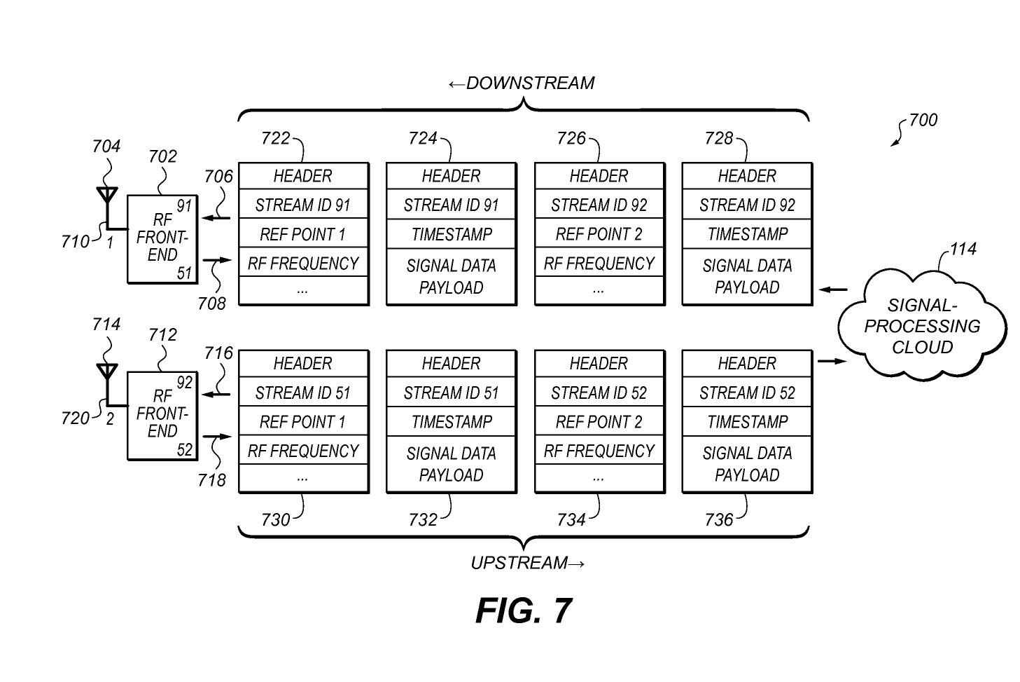

Various aspects permit a spectrum sensor 102, 108 to be controlled by a metadata packet to control its parameters such as RF frequency, resolution, or bandwidth. Therefore, while the IQ data is transmitted only in one direction, metadata transmission can be in both directions in various examples, e.g., as discussed below with reference to FIG. 7.

Various aspects include using VITA 49 as a cloud interface. In some examples, in a conventional system, receipt, downconversion and demodulation are performed in the analog system. The data are digitized and digital data, plus metadata indicating, e.g., the carrier frequency, are transmitted to the radio.

In some examples, the data are transmitted to cloud 114 instead of to digital electronics within one radio. Different types of spectrum sensors can be controlled by cloud 114, e.g., using control packets. Context and signal packets from the spectrum sensors can be received by cloud 114 and used to process data appropriately. A spectrum sensor can be deployed without digital electronics except for the packet interface. In some examples, all control is performed in cloud 114. In some examples, the digital subsection of a radio is divided between the spectrum sensor 102, 108 and the cloud 114. In some examples, interpolation, decimation, compression, or other processes independent of the specific air interface (RAT) in use can be performed in the spectrum sensor 102, 108 and RAT-specific processing can be performed in the cloud 114. In some examples, processing to provide a baseband signal can be performed in the spectrum sensor 102, 108 and at-baseband processing can be performed in the cloud 114. In some examples, layered protocol stacks are used, e.g., according to the OSI seven-layer model or other models such as the TCP/IP model. Some example stacks include the following layers in order: physical (e.g., PHY), data link (e.g., MAC), network (e.g., IP), and transport (e.g., TCP or UDP). Processing for a selected protocol layer (e.g., MAC) and lower can be performed in the spectrum sensor 102, 108, processing for protocol layers above the selected protocol layer can be performed in the cloud 114.

FIG. 1 illustrates a cognitive radio cloud. In FIG. 1 the cloud provider manages the infrastructure that runs the radio software. The RF-digital interface can be the interface between the RF FPGA and the cloud 114. The RF-digital interface can be open and software-based. The cloud 114 in FIG. 1 can be a distributed antenna system, in which a distributed signal processing facility is connected to a remote antenna over an analog RF cable. In general, the RF FPGA may be connected to the cloud over the Internet.

In some examples, spectrum sensors 102, 108 are cognitive radios including cognitive engines (CEs). A CE is an “intelligent” agent that manages the cognition tasks in a cognitive radio. In some examples, the CE learns from the current operating environment and from previous events, examines the situation, determines and automatically carries out the appropriate response. The CE can be implemented as an independent entity interacting with the reconfigurable RF front-end, or as a collection of interacting entities each fulfilling a specific role. In some examples, the CE can determine which radio protocol is active at any one time, and at what parameters, such as RF center frequency and RF power this protocol will operate. Cognitive devices can dynamically detect available RATs and available resources.

FIG. 2 shows a block diagram of a software-defined radio (SDR) system, e.g., embodied in sensor 102. The SDR system is connected to antenna system 202, e.g., antenna 104, 110, FIG. 1.

As FIG. 2 shows, the illustrated RF front end is not entirely analog; it includes an analog front end (AFE) and a digital front end (DFE). In this example, the AFE includes amplify/filter/convert block 204 and analog-to-digital/digital-to-analog (ADC/DAC) block 206. The DFE 208 can, e.g., perform interpolation or decimation to increase or decrease the sampling frequency. Furthermore, the down-conversion and up-conversion can be implemented partially or even entirely with digital signal processing (DSP). In some examples, the RF front end or “RF client” can include antenna system 202, amplify/filter/convert block 204, ADC/DAC block 206, and DFE 208. Any of antenna system 202, amplify/filter/convert block 204, ADC/DAC block 206, or DFE 208 can be connected to digital hardware 210, e.g., via an RF-digital interface as described herein. Digital hardware 210 can be connected to a user I/O block 212. In the illustrated example, software drivers 214 and a real-time kernel 216, e.g., of an operating system, communicate with digital hardware 210 or user I/O 212.

In an example software-defined radio (SDR), the radio access technologies (RATs) at the baseband level are implemented entirely in software. A RAT 218(1), 218(N) (individually or collectively referred to herein with reference 218) can implement a radio protocol, or aggregation of protocols. For radio protocols implemented entirely in software, the digital hardware platform 210 can be programmable. Such platforms can be built with general-purpose processors, digital signal processors, or field programmable gate arrays (FPGAs).

Software-defined radios can include radios for which RF operating parameters can be modified by software. Example operating parameters can include frequency range, modulation type, or output power.” An example SDR system can implement radio protocols defined after manufacture of hardware components of the SDR system, e.g., using an additional or modified RAT 218. SDR architecture can include interconnected hardware and software components, e.g., upgradable software and hardware. Example SDR architectures allow the adding, upgrading, and swapping of hardware and software components. An example SDR architecture includes hardware, system software, and service software layers, illustrated in FIG. 2.

The example radio shown in FIG. 2 can operate using any one of N different RATs 218, such as Wi-Fi, GSM, and LTE-Advanced. The center frequency and power at the RF level can be considered completely independent of the radio protocol (RAT 218). A cognitive engine (CE) 220 can determine which radio protocol is active at any one time, and at what parameters (such as center frequency and power) this protocol will operate. FIG. 2 can also describe radios that are not software-defined (“non-SDR”), in which the radio protocols (RATs 218) are implemented with dedicated hardware that is not programmable. In some examples of such hardware radios, each radio protocol (RAT 218) can be connected, e.g., using a closed RF-digital interface, to a separate RF front end.

In both SDR and non-SDR, a radio can support other software applications 222(1)-222(N) (individually or collectively referred to herein with reference 222. Applications 222 can use services provided by real-time kernel 216. An example difference between these software applications 222 and radio protocols (RATs 218) implemented in software (or “radio software,” for short) is that the radio software can have much greater execution-speed requirements. As a result, the radio software can't be made completely independent of the digital hardware 210, which is indicated by the dotted lines in FIG. 2. This is the main barrier to implementing radio protocols 218 entirely in software. In some examples, the RF-digital interface is closed, the radio protocols (RATs 218) can be hardware dependent.

Various examples of open architectures use defined interfaces. For example, the Software Communications Architecture (SCA) defines a set of interfaces that isolate the radio applications from the hardware. In another example, APIs (application program interfaces) defined in C++, VHDL (VHSIC Hardware Description Language), and IDL (Interface Definition Language) can permit interfacing a waveform application 222 to a radio, e.g., to make the waveform software portable onto different platforms.

In some examples, an RF-digital interface as described herein provides hardware modularity. Some example RF-digital interfaces for SDR include a hardware bus-type interface. Some example RF-digital interfaces described herein can operate at various clock speeds and data rates. Some example RF-digital interfaces described herein transmit metadata, including parameters such as frequency and power. Some example RF-digital interfaces described herein specify not only receiver interfacing, but also transmitter interfacing or control of the receiver. Some example RF-digital interfaces described herein include a packet-based interface that lets the RF subsystem and the digital subsystem be replaced independently of each other. Some example RF-digital interfaces described herein describe the RF front end and can thus be used as a hardware abstraction language for the RF front end.

In various example, digital hardware 210 or other components of the radio include one or more reprogrammable RF FPGA(s) that include one or more components such as low-noise amplifiers, power amplifiers, mixers, filters, or matching networks. In various examples, the components, the topology, or both are software-defined. In some examples, an RF FPGA can include data converters or digital signal processing that is independent of the radio access technology (RAT 218). Examples of such processing can include decimation or interpolation. In some examples, such an RF FPGA can be or be part of a “thin radio client.” A thin radio client can include, e.g., an RF front end and a packet-based RF-digital interface. A “fat radio client” can include, e.g., both analog resources such as those found in a thin radio client and processing resources to perform baseband processing of received signals or signals to be transmitted.

RF FPGAs in some examples can implement RATs 218 to be defined after manufacture of the RF FPGA. According to some prior schemes, RF ICs are optimized for a single RAT and are re-designed for every new RAT. Moreover, RF ICs according to some prior schemes are connected with a closed interface to the digital hardware for which they are designed. RF FPGAs as described herein can be RAT-independent, so can use an open (non-RAT-specific) interface. Various examples herein of an open interface and a HDL for RF FPGAs include packet communications.

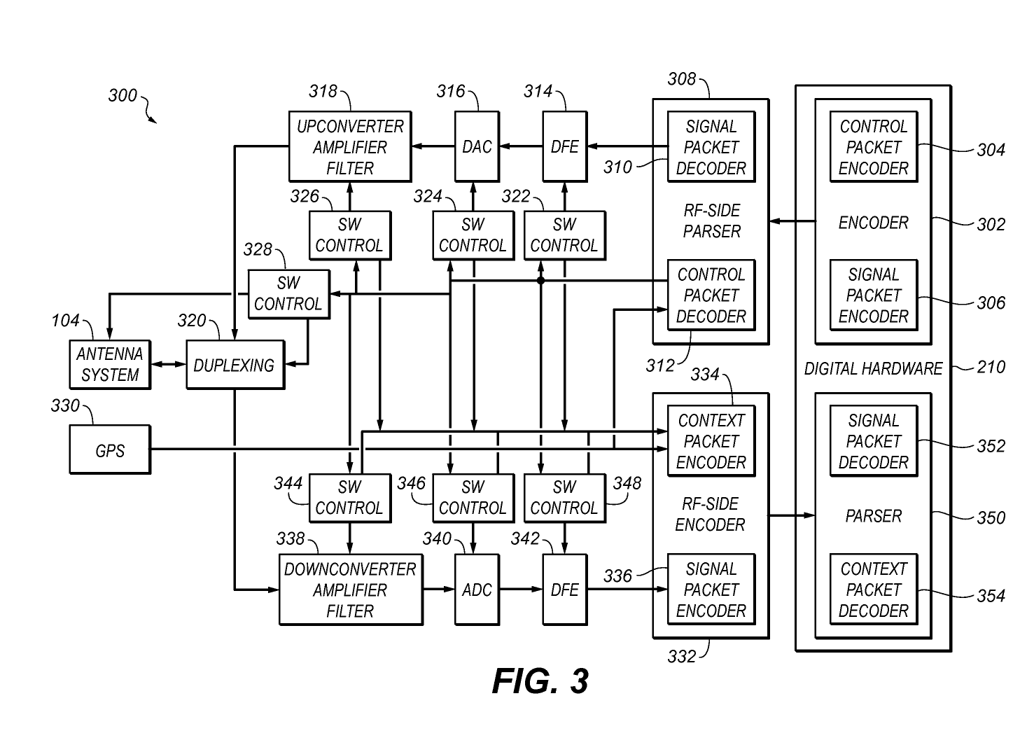

FIG. 3 shows an example RF-digital interface and related components of a radio 300. In this example, digital hardware 210 includes encoder 302 having control packet encoder 304 and signal packet encoder 306. Packets from encoder 302 are transmitted across the RF/digital interface to RF-side parser 308 including signal packet decoder 310 and control packet decoder 312. Signal packets from signal packet decoder 310 include data to be transmitted. These data pass through digital front end (DFE) 314 and digital-to-analog converter (DAC) 316. Analog data from DAC 316 passes through upconverter/amplifier/filter (UAF) block 318 and duplexer 320 to antenna system 104. Software control modules 322, 324, and 326 control the operation of DFE 314, DAC 316, and UAF 318, respectively, in response to signals from control packet decoder 312. Software control module 328 controls the operation of duplexer 320 and antenna system 104 in response to signals from control packet decoder 312. In some examples, Global Positioning System (GPS) receiver 330 or another location sensor provides information of a location of radio 300.

The RF-digital interface is also connected to RF-side encoder 332 including context packet encoder 334 and signal packet encoder 336. Received data from antenna system 104 passes through duplexer 320 to downconverter/amplifier/filter (DAF) block 338 and then to analog-to-digital converter (ADC) block 340. Digital data from ADC 340 passes through a receive-side DFE 342, which provides data to signal packet encoder 336. Software control modules 344, 346, and 348 control the operation of DAF 338, 340, and 342, respectively, in response to signals from control packet decoder 312. Software control modules 322, 324, 326, 328, 344, 346, or 348 can additionally or alternatively detect or report status or capability information about components to which they are attached.

Context packet encoder 334 provides data derived from or produced based at least in part on various sources. Such sources can include control packet decoder 312, GPS 330, or software control modules 322, 324, 326, 328, 344, 346, or 348. Parser 350 in digital hardware 210 receives packets from RF-side encoder 332 via the RF-digital interface. Parser 350 includes signal packet decoder 352 and context packet decoder 354.

Various examples define an open interface for a radio receiver, e.g., having a fixed topology, e.g., a fixed arrangement of analog components. Various examples define a packet-based interface, e.g., a software bus. There are packet encoders and parsers/decoders on either side of the connection (e.g., encoder 302 paired with RF-side parser 308 or RF-side encoder 332 paired with parser 350).

Various examples include a packet connection between the RF and digital subsystems (FIG. 3). Over this packet connection, there can be, e.g., six packet types that implement the interface: data, context, control, extension data, extension context, and extension control packets. In some examples, the data, context, and control packet types are used. In some examples, one or more of the extension packet types are used in addition to data, context, or control packets. Each packet can have a header conveying the type of that packet. If a decoder 310, 312, 352, 354 does not support a particular extension packet type, that decoder can ignores the content of that packet and can, e.g., provide feedback indicating a potential problem. In some examples, packets, e.g., of any of the six packet types listed above, can include timestamps to enable synchronization. For example, control packets can be time-stamped so that the software-defined elements in the RF front end are configured at the specified time.

Various aspects define control and extension control packets, in addition to data and context packets. In various aspects, context packets can include parameters to both the transmitter and receiver, plus additional parameters such as reconfiguration time or partial vs. full reconfiguration. Collectively these parameters can describe the RF FPGA in some examples. In response to change(s) in one or more of these parameters, the RF-side encoder 332 in some examples sends a context packet containing the current value of the parameters that have changed. Initially, the RF FPGA sends an extension context packet to describe its capabilities. The topology (and therefore the performance) of the RF FPGA can be reconfigured using commands carried in control packets. Reconfiguration can be performed as in a digital gate-level FPGA. The control packets in some examples are generated by digital hardware 210 and can contain metadata also pertaining to both the transmitter and receiver. These control packets are the RF FPGA reconfiguration commands.

Controlling the topology of an RF FPGA can be done, e.g., using reference points. The control packet decoder 312 translates the metadata to the hardware settings of each component on the RF FPGA. Note that this description has a hierarchical structure, because the metadata descriptions of several circuit elements can be combined into aggregate context or control packets. This aggregate control or context packet can describes the RF FPGA.

The RF-digital interface in FIG. 2 includes both high-speed data and low-speed metadata. Unlike some prior radios, in SDR according to various examples the metadata are not necessarily constant or predetermined. In some examples, the RF-digital interface conveys metadata explicitly.

In some examples, a transmitter includes digital-to-analog converter (DAC) 316, followed by an up-converter, power amplifier (PA), and transmit RF filter (UAF 318). An up-converter or down-converter generally includes a local oscillator, mixer, and a filter. The local oscillator's frequency can be software-defined. After up-conversion, the RF signal is amplified using the PA, for which gain and output power are the main programmable parameters. To adjust the transmit power level, a programmable attenuator can be included (not shown). The receiver includes channel-select RF filter, amplifier, and downconverter (DAF 338), and analog-to-digital converter (ADC) 340. Example parameters of programmable RF filters can include RF, bandwidth, out-of-band attenuation, or stop-band edge. A programmable impedance-matching circuit (not shown) can also be used. A duplexer 320 separates the transmit and receive paths, e.g., in time or frequency. The antenna and the duplexing technique can also be software-defined. In some example SDR devices, not all parameters are software-defined. The specific way parameters are programmed is hardware-dependent and can be isolated from the RF-digital interface. Information about which parameters are programmable and which are not programmable can be conveyed by a thin radio client to digital hardware 210, e.g., by a description expressed in terms of an ontology as described below.

In various examples, the RF front end generates context packets and the digital hardware 210 generates control packets. In some examples, any or all types of metadata packets can be transmitted in either direction. Context packets can include parameters pertaining to the transmitter or the receiver. Example parameters can include RF (e.g., carrier frequency over the air), IF (intermediate frequency), bandwidths, ADC and DAC sample rates, ADC, and DAC number of bits, gain, voltage full-scale range, filter order, out-of-band attenuation, stop-band edge, transmit output power, reference point, timestamp, timestamp delay, or location.

Control packets can include metadata specifying any, or any number or combination, of the following: the reference point, timestamp, or output power pertaining to the transmitter, the DAC or ADC sample rate, DAC or ADC number of bits, reference level, voltage full-scale range, RF, IF, local oscillator (LO) power, bandwidth, gain, filter order, out-of-band attenuation, or stop-band edge pertaining to both the transmitter or receiver. In some examples, all RF front-end parameters that are software-defined can be controlled via values included in control packets. The control packet decoder 312 can be coupled to the analog front end and can translate the metadata to each programmable device's hardware settings.

In addition to the data, context, and control packets, various examples include one or more of extension data, extension context, or extension control packets. The interface is extensible using extension packets. For example, additional parameters can be defined in extension control packets. For example, extension signal packets could carry spectrum information. The extension context packets can be used to convey, e.g., bit error rates, power supply voltages, or receiver noise figures. In some examples, extension signal packets can include representations in other than IQ form of received data, e.g., spectral data such as that provided by a fast Fourier transform (FFT). In some examples, extension packets can include results of processing performed, e.g., at the spectrum sensor 102. In some examples, extension packets are used to exchange data between digital logic sections in the RF front-end or thin radio client and digital logic sections in the cloud.

In some examples (omitted for brevity), a radio 300 can include power-management circuitry that can, e.g., turn off parts of the radio when not in use. In some of these examples, power-management information can be specified in extension control packets.

At the RF-digital interface, encoders 302, 332 and parsers 308, 350, respectively, exchange multiplexed streams of packets (FIG. 3). The interface to the RF transmitter has a packet encoder 302 on the digital hardware side and a packet parser 308 on the RF side. The output of the packet encoder 302 can be a stream of multiplexed signal and control packets (and optionally extension signal packets or extension control packets). The parser 308 on the RF side receives this stream and separates the control packets from the signal packets. The payload of the transmit signal packets is fed to the DAC 316. The parameters specified in the control packets are translated into a hardware-specific format for every software-defined element.

Circuit elements of the RF front end in FIG. 3 can be controlled individually using control packet(s). In some examples, various parameters have respective minimum and maximum values. For example, the RF front end should not be directed to tune to a particular frequency if it cannot operate at that frequency. Various aspects make the tuning range or other metadata of the radio accessible. This permits the control packet encoder 304 of digital hardware 210 to produce control packets based at least in part on the tuning range(s) or other parameters of relevant component(s). In some examples, access to metadata such as tuning range is provided by context packets or extension context packets. In some examples, generally-constant parameters such as tuning range of a particular RF front end can be specified in extension context packets transmitted by the context packet encoder 334.

The RF side also has a packet encoder 332 connected to a packet parser 350 of the digital hardware 210. The elements in the receiver chain (e.g., elements 338, 340, and 342) can be connected in a hardware-dependent way to the context packet encoder 334, which in turn produces context packets with information such as, e.g., RF, IF, bandwidth, or sample rate. The context packet encoder 334 can also receive or track GPS data from GPS 330 and include location information in the context packets. The output of the RF-side packet encoder 332 can include, e.g., a stream of multiplexed signal and context packets (and optionally extension signal packets or extension context packets). From this stream, the digital-side parser 350 can separate the packet types and processes them appropriately.

In some examples, the metadata (control and context) packets are multiplexed with the signal packets. However, in some examples the metadata packets are not sent as often as the signal packets. For example, control and context packets can be sent only when the relevant metadata changes. In some examples, the metadata is persistent between updates (e.g., changes only when a metadata packet is received). This reduces overhead due to the control and context packets in proportion to how often parameters such as the center radio frequency and bandwidth change. Sampling periods can be on the order of nanoseconds, while metadata parameters such as center frequency can change on the order of milliseconds in some examples. Therefore, the time to transmit the metadata can be negligible compared to the time to transmit the signal packets.

In some examples, an RF-digital interface as described herein is independent of the PHY and MAC used by the wireless system, and is independent of the specific technique to carry the packets. This can permit modular construction of radio systems. For example, the connection between the RF front end and the digital hardware 210 can be implemented using Gigabit Ethernet. Although the connection could reside at OSI layer 2 (data link) and below, it could also be implemented as a full network stack using, e.g., Transmission Control Protocol (TCP) or User Datagram Protocol (UDP).

In some examples, a transmitter-configuration subsystem is configured to reconfigure the RF transmitter in response to a received transmitter-control packet. The transmitter-configuration subsystem can include, e.g., control packet decoder 312 and one or more of software control modules 322, 324, 326, or 328.

In some examples, a receiver-configuration subsystem is configured to reconfigure the RF receiver in response to a received receiver-control packet. The receiver-configuration subsystem can include, e.g., control packet decoder 312 and one or more of software control modules 328, 344, 346, or 348.

In some examples, a reporting subsystem is configured to transmit a context packet including both data of a state of the RF transmitter and data of a state of the RF receiver. The reporting system can include context packet encoder 334, at least one of software control modules 322, 324, 326, or 328, and at least one of software control modules 328, 344, 346, or 348.

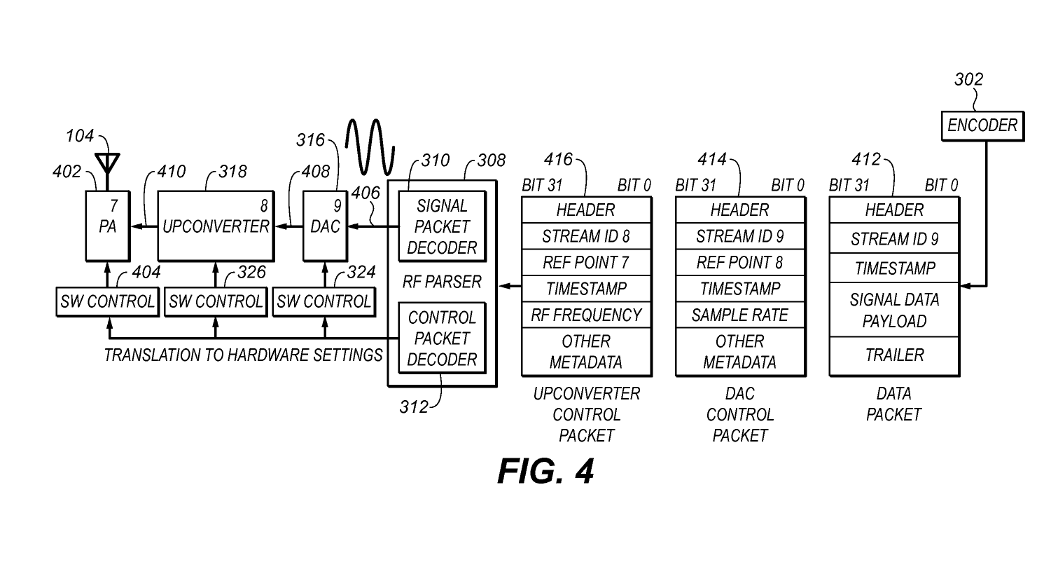

FIG. 4 shows an example radio transmitter and example control and signal packets. Three reference points—a digital IF signal, the DAC output, and an RF signal—describe the RF front end's topology at a coarse level.

Antenna 104 is connected to a power amplifier 402 controlled by software control module 404. An upconverter 318 is controlled by software control module 326 and a DAC 316 is controlled by software control module 324, as discussed above with reference to FIG. 3.

The portion of the radio to which a particular metadata item applies can be specified as a reference point. For instance, the center frequency or power-level characteristics can correspond to a particular reference point. In some examples, metadata packets include reference points.

The ability to multiplex different packet types onto the same connection (RF-digital interface) is supported by Stream Identifiers or IDs. Signal and metadata packets that share a stream identifier are related, referred to as data-metadata pairing. A signal packet stream and a paired metadata packet stream form an information stream. For example, a signal packet can be transmitted with the RF parameters specified in the most recent paired control packet. In an information stream, there can be thousands or millions of signal packets between metadata packets. There could be multiple information streams, for example, if there are multiple spatially-separated RF units fed by respective, different information streams.

The timestamp in signal packets sent from the RF-side encoder can, e.g., indicate the local time at the time of timestamping. In some examples, the antenna can be used as a reference point to determine the time (e.g., a particular instant, with selected granularity) a signal is impinging on the antenna. The RF-side encoder 332 can introduce delay between a signal that arrives at the antenna and corresponding transmitted signal packets, e.g., due to the delays introduced by the various electronic circuits in the RF front end. In some examples, packets can include timestamp or timestamp adjustment field(s) to account for delays prior to attaching the timestamp. In some examples in which the reference point is the antenna, negative timestamp adjustments can be included in packets, indicating that events at the reference point occurred earlier than the timestamp specifies. The timestamp adjustment can be a single value, e.g., for a specific RF front end, and can be but does not have to be equal to a multiple of the sampling period. For signal packets sent to the RF front end by encoder 302, the timestamp can refer to the time at which emission of the data should commence. In some examples, the actual transmission will start with a delay that is equal to the timestamp adjustment.

In some examples, together with timestamps, GPS data can be used to provide synchronization. In some examples, other techniques for clock and time-of-day synchronization can be used, e.g., without GPS. In this way, even radios that are at geographically different locations can operate synchronously.

The example system shown in FIG. 4 has three reference points—the digital IF signal 406 fed to the DAC (“9”), the DAC output 408 (“8”), and the RF signal 410 at the output of the up-converter (“7”). 9, 8, and 7 are example assigned IDs of these reference points. These reference points describe or correspond to the RF front end's topology.

Encoder 302 can provide packets. A signal packet 412 and two control packets 414, 416 are shown. Each illustrated packet includes a header and a stream ID. The signal packet 412 is discussed below. Control packet 414 corresponds to DAC 316 and can include data of, e.g., sample rate, number of bits, and reference level. Control packet 416 corresponds to the up-converter 318 and can include data of, e.g., RF, IF, and bandwidth. An IF frequency of zero can indicate up-conversion from baseband.

FIG. 4 also shows a nonlimiting example format of packets. The first word is a header that contains information about the packet type and packet size. The header is followed by a stream identifier, a reference point (shown in the control packets), and an optional timestamp. For signal packets, the time stamp is followed by the payload. For context and control packets, the timestamp is followed by metadata parameters.

In some examples, the metadata descriptions of several circuit elements are combined in a single packet. In some examples, all transmit or receive circuit elements of the SDR architecture can be described with a single packet. In some example, the metadata are expressed in terms of, or constitute, a hierarchical description language for the RF front end. Control and context packets to and from each component and can be aggregated to generate aggregate control or context packets. In some examples, an aggregate control or context packet can describe an entire RF front end, e.g., with the reference point being the antenna. For example, the up-converter control packet 416 and the DAC control packet 414 in FIG. 4 can be combined into a single control packet.

FIG. 5 shows an example radio receiver having a packet interface device 500. Antenna 104 is connected to tuner 502, which provides analog data to ADC 504. Digital data from ADC 504 is provided to interface device 500 and can be provided to local DSP block 506. Outputs from DSP 506, e.g., Fourier transforms of signals, can be provided to interface device 500. Software control modules 508, 510, and 512 can control the operation of, and report status or capabilities of, tuner 502, 504, and 506, respectively.

Interface device 500 can include a compression/signal packet encoder 514, an extension packet encoder 516, and a metadata packet encoder 518. Interface device 500 can communicate with signal-processing cloud 114 via link 116.

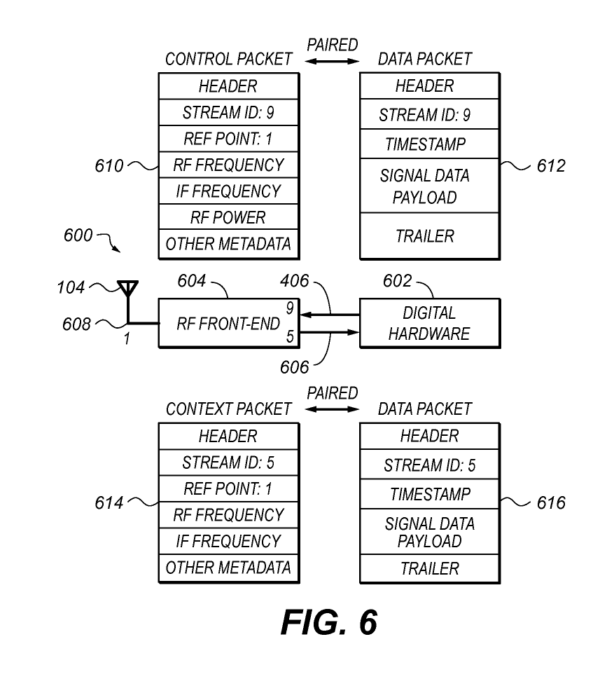

FIG. 6 shows an example wireless relay 600 having digital hardware 602 and an RF front-end 604 connected by links 406 (transmit) and 606 (receive). RF front end 604 is connected via link 608 to antenna 104. In some examples, the RF front end 604 can implement a repeater without digital hardware 602.

In some example wireless systems, there is coordination and cooperation among radios to reduce the probability of error. For example, if data is relayed, two or more independent copies are received at the destination, improving the robustness. FIG. 6 illustrates the operation of an example relay with aggregate context and control packets that are paired with the respective signal packets. In the illustrated example, control packet 610 is paired with signal packet 612 and context packet 614 is paired with signal packet 616. Amplify-and-forward or decode-and-forward relaying techniques can be used.

FIG. 7 illustrates an SDR cloud system 700 that has two information streams, one for each of spatial streams corresponding to respective RF front ends. Various examples include distributed antenna systems or SDR clouds, in which the RF front end is collocated with the antenna, whereas the digital signal processing is performed remotely at a data center, conceptually similar to cloud computing. The example SDR cloud system 700 can support wireless techniques such as joint transmission that require coordination among the spatial streams. In joint transmission, multiple devices jointly transmit data to another device to improve the received signal's quality. In some examples, metadata packets are used to coordinate the transmissions. In some example SDR clouds, an RF-digital interface as described herein is the interface between the RF front end(s) and the cloud 114.

FIG. 7 shows an example multiple-antenna SDR system, e.g., a multiple-antenna SDR cloud system 700. As discussed above with reference to FIG. 1, a radio can include a cognitive engine (CE). Using CEs, radios can use description techniques for the objects in the wireless realm. Various aspects herein relate to a hardware abstraction and a semantic description for RF FPGAs, e.g., having an RF-digital interface. Radios having CEs can participate in cognitive radio clouds using a wireless ontology to permit semantic wireless networking.

In the example of FIG. 7, cloud 114 communicates bidirectionally with RF front-end (RFE) 702 having antenna 704. Link 706 has a stream ID of 91 and corresponds to packets from cloud 114 to RFE 702. Link 708 has a stream ID of 51 and corresponds to packets from RFE 702 to cloud 114. Link 710 connects RFE 702 to antenna 704.

Cloud 114 also communicates bidirectionally in the illustrated example with RF front-end (RFE) 712 having antenna 714. Link 716 has a stream ID of 92 and corresponds to packets from cloud 114 to RFE 712. Link 718 has a stream ID of 52 and corresponds to packets from RFE 712 to cloud 114. Link 720 connects RFE 712 to antenna 714.

Packets 722, 724, 726, and 728 represent example packets sent (“downstream”) by cloud 114 to RFEs 702, 712. Packets 722 and 724 have a stream ID of 91, so are sent via link 706 to RFE 702. Packets 726 and 728 have a stream ID of 92, so are sent via link 716 to RFE 712. Packets 730, 732, 734, and 736 represent example packets received (“upstream”) by cloud 114 from RFEs 702, 712. Packets 730 and 732 have a stream ID of 51, indicating they have been sent from RFE 702 via link 708 to cloud 114. Packets 734 and 736 have a stream ID of 52, indicating they have been sent from RFE 712 via link 718 to cloud 114. As shown the downstream and upstream packets can include signal packets (e.g., packets 724, 728, 732, and 736), control packets (e.g., packets 722 and 726), context packets (e.g., packets 730 and 734), or packets of other types described above.

Various aspects relate to radios intercommunicating in semantic wireless networks. In a semantic wireless network, radio clients can, e.g., use services that are dynamically discovered without prior negotiations between client and service providers. Note that in addition to radio clients and service providers there may be middle agents; the term “agents” includes all of these. All agents can access and interpret ontologies, e.g., Web-published ontologies, and communicate using messages whose content is represented or can be interpreted, in terms of published ontologies or statements therein.

Ontology is a general mechanism to describe objects in a certain domain and the relationships among these objects. For example, a cognitive radio ontology can include a description of an RF device, networks, services that are available, and policies to be followed. Examples of parameters described in an ontology are given herein. For purposes of explanation, and without limitation, various examples are given with reference to a nonlimiting device with RF frequency between 5000 and 6000 MHz, RF bandwidth between 1 and 20 MHz and output power between −4 and 30 dBm.

According to some examples, a cognitive radio ontology can provide an ontological representation of the transmitter API. Such an ontology can, e.g., define possible radio protocols and describe the basic terms of wireless communications, such as “bit,” “symbol,” and “channel model.” Ontologies can relate to an RF-digital interface as described herein. For example, parameters defined in metadata packets (e.g., control or context) as described herein can be included in a radio ontology in order to describe the RF front end in a way that can be automatically processed.

The Resource Description Framework (RDF) is an example language in which an ontology can be expressed. Each RDF statement, or “triplet,” associates a subject, a predicate, and an object. The subject is the resource being described. The predicate is a property of the subject, and the object field contains the value of this property. An example ontology based on the Resource Description Framework (RDF) is the Network Description Language (NDL).

Another example is the Web Ontology Language (OWL), e.g., using the OWL 2 Direct Semantics, which is the de facto standard for the Semantic Web. There are three dialects of OWL: OWL-Lite, OWL-DL, and OWL-Full. OWL-DL is the most popular dialect because it provides significant expressive power and supports practical reasoning algorithms. An OWL-based cognitive radio ontology can be prepared. The Rule Interchange Format (RIF) is a relatively new standard that can be used in combination with OWL. OWL ontologies can be represented using various syntaxes, including but not limited to the Manchester syntax used herein for various examples. Various aspects of radios or semantic wireless networks herein employ or interoperate using metadata packet descriptions using ontologies (e.g., encoded in RDF or OWL). Note that measurement units are not part of OWL. However, reasoning with them can be easily introduced. For example, units (e.g., the SI metric system) can be introduced and syntactic rewrites can be applied.

Service providers in an example semantic wireless network as described herein, e.g., radios, can publish descriptions of their capabilities using a formal description language, such as OWL-DL. Clients or other agents can search those published descriptions using an ontology query language, interpret these descriptions, and select appropriate services. As a result of this style of interaction, clients can adjust smoothly when new devices and new RATs are introduced. In an example semantic wireless network, participating radios can, on their own and without human intervention, carry out tasks such as identifying available spectrum and spectrum usage policy; if necessary, buying or renting spectrum; identifying available networks and RATs; or selecting a network or RAT to use. The radios can select RF frequency, RAT, or network to comply with one or more applicable policies based on geographic location, user preferences, etc. In some examples of semantic wireless networks offering “personalization,” different users have access to different parts of the ontology descriptions and the network behaves differently for different clients.

In some examples, the cognitive engine (CE) can include or employ a semantic search engine. In some examples, a cognitive radio has a stand-alone search engine. In a stand-alone search engine the crawler browses the description documents of policies, hardware, etc., created according to the cognitive radio ontology. Then the document metadata is stored in an index based on which the query engine evaluates query requests. In some example, the cloud 114 architecture facilitates the semantic search done by the CE and allows a different type of a search engine, where there is no index of documents. Instead, the search engine distributes queries to other search engines and combines the results afterwards.

A “cognitive radio” can be configured to perform some or all of the following: determine properties of its environment (operational or geographical), determine or access relevant policies, autonomously adjust its operation based on the determined properties and policies, measure results after adjustment, and learn from the results.”

In some examples, a cognitive radio has domain knowledge of radio communication. On the basis of this knowledge, the CE can determine parameters and protocols to use in various situations. In some examples, the CE has hardware-specific knowledge, e.g., metadata parameters such as center RF and power level that are physically determined only by the RF front end. In some examples, an ontology provides a hardware abstraction isolating the CE from the underlying hardware and making the CE portable, e.g., as discussed above with reference to FIG. 2. In some examples, a cognitive radio supports multiple radio protocols and uses an open RF-digital interface as described herein.

In some examples, a published ontological description of a radio can include statements indicating, e.g., the minimum and maximum RF frequencies at which the radio can transmit, or the minimum and maximum bandwidths at which the radio can operate. To enable queries and responses of such descriptions, it is convenient to use a simple ontology scheme such as RDF. The mapping between such ontology descriptions and the context and control packets can be one to one.

This description method allows queries to be made and answered. The query can be a series of triplets in which some of the slots contain variables. For example, a query in the “SPARQL” RDF query syntax about the minimum and maximum RF frequency can be as shown in Table 2.

TABLE 2

```
PREFIX sdr: <http://opensdr.org/sdr/>
SELECT ?xmin ?xmax
WHERE {
  ?x sdr:MinRFfrequency ?xmin .
  ?x sdr:MaxRFfrequency ?xmax .
}
```

If this device operates between 5,000 MHz and 6,000 MHz, the response in an example can be as shown in Table 3.

TABLE 3

<sdr:Device rdf:about=“#DeviceID”/>
<sdr:MinRFfrequency rdf:resource=“#5000 MHz”/>
<sdr:MaxRFfrequency rdf:resource=“#6000 MHz”/>

The #-prefix indicates that the device is defined in a local namespace. With this description method, a radio can also be asked to adjust its operating parameters. For example, to ask the radio to tune to 5,200 MHz, a request can be used such as in Table 4.

TABLE 4

<sdr:Device rdf:about=“#DeviceID”/>
<sdr:Purpose rdf:about=“ChangeState”/>
<sdr:RFfrequency rdf:resource=“#5200 MHz”/>

If the devices are synchronized, then a Timestamp such as shown in Table 5 can be added to specify an exact time instant when these parameters should be changed.

TABLE 5

<sdr:Timestamp rdf:resource=“#value”/>

Metadata packets, e.g., control, context, extension control, and extension context, can be represented using such formal, computer-processable semantics. Using ontologies permits descriptions to be provided in any order. Moreover, any particular RDF applications is not required to understand the complete description. Agents can extract desired information from a published ontological description and ignore other information. This permits extending the ontology or the published descriptions while maintaining backwards compatibility. Published ontological descriptions can therefore describe the current operational status and capabilities of RF components.

The metadata can be described using ontologies, e.g., a wireless ontology. This ontology language can be used to represent the metadata produced by every spectrum sensor, for example as in Table 6.

TABLE 6

```
SpectrumSensor and
  RFFrequency some MHz [>=30, <=6000] and
  Resolution some KHz [>=10, <=1000]
```

Service providers (both in the cloud and in thin clients) can advertise in a service registry the descriptions of their capabilities. Clients can search using an ontology query language, interpret these descriptions, and select appropriate services. With declarative APIs the ontology can support the automatic execution of these services. Furthermore, not only the metadata, but policies such as spectrum licenses established by regulatory body can also be described using the ontology, e.g., as shown in Table 7.

TABLE 7

```
Band1 SubClassOf Band and
  Unlicensed and
  (bandwidth some MHz [>=900, <=928]) and
  (maxPower some mW [<=1000])
```

In some examples, an OWL (or other ontological) reasoner can determine if spectrum-sensing results contradict existing over-the-air policies, automatically identify spectrum-sharing opportunities, and evaluate the efficiency of actual spectrum usage.

Various parameters can be described by an ontology. Examples are given below.

Example parameters can include the current parameters and capabilities and topology of the RF FPGA or other RF front end. For example, parameters in the control and context packets can be described. Examples are given in Table 8.

TABLE 8

```
Device and
  RFFrequency some MHz[>=5000 <=6000] and
  RFBandwidth some MHz [>=1 <=20] and
  OutputPower some dBm [>=−4 <=30]
```

An example describing the topology of an RF front-end can be as in Table 9.

```
TABLE 9
RFFPGA SubClassOf
  contains 1 (Filter and bandwidth some MHz [>=20]) and
  connected_to min 1 LNA and
  connected_to min 1
    (Analog_Digital_Converter and number_of_bits some int[>=6])
```

Note that the mapping between such ontology descriptions and the context and control packets introduced earlier can be one-to-one.

Example parameters can include parameters of the digital hardware 210 such as speed (MIPS) and memory for processor(s) therein. A variety of processors may be available, such as digital FPGAs GPP, and DSPs. There may be also hardware accelerators for certain tasks. The parameters that need to be described depend on the technology. For example, for FPGAs the parameters can include the number of configurable logic blocks, number of I/O pins, I/O logic level, configuration method, or power consumption.

Example parameters can include RAT types such as: GSM, Bluetooth, IEEE802.11a/b/g/n, or LTE. Example parameters can include MAC-level protocols such as IEEE802.11r, IEEE802.21, etc.

Example parameters can include system parameters, e.g., location of an RF front end. For example, battery life can be used in energy-aware computing.

Example parameters can include information and user types. Examples can include types of data, types of users, priorities, or Quality of Service (QoS) parameters.

Example parameters can include current network topology, available networks, and their parameters (data rates, cost of access, security protocols, etc.).

For example, to describe a Wi-Fi device that is connected to an Access Point (AP), one can use a statement such as that in Table 10:

TABLE 10

Device and connectedTo some (BSSID value [XXXXXX])

The AP with the above basic service set identification (BSSID) (represented above as “XXXXXX”) can be described as having Ethernet interface. Note that the device can be connected to other devices as well.

Example parameters can include spectrum etiquette parameters. Spectrum etiquette can be defined as the algorithm that controls a device's spectrum usage. The etiquette can include RF frequency, bandwidth, start time and duration of transmissions, power mask, antenna pattern and polarization. For radios that perform dynamic spectrum access spectrum sensing parameters need to be described. These parameters include some characteristics of the RF front-end, described in part 1). For example, the frequency range, polarization, and antenna gain impact the sensing characteristics. Other relevant parameters can include channel monitoring time, channel monitoring bandwidth, and presence of secondary rendezvous beacon (with which secondary radios share information).

Example parameters can include policies, such as regulatory policy, service provider policy, user policy, mission policy, security policy, vendor policy, etc. To resolve potential conflicts among them, policies can have different priorities. In some examples, values and fields in control or context packets (or extension control or extension context packets) can correspond with statements expressed in terms of a predefined ontology. Policies can be provided from outside the radio system, e.g., by human domain experts, and can be represented as collections of statements expressed in terms of the predefined ontology. An inference engine can be applied to ontological statements corresponding to metadata and to policies to determine consequences of those statements that are consistent with the ontology. Those consequences or other results from the inference engine can be used to control a radio.

An example cognitive radio ontology as described herein can have at least some of the following properties: (1) the description method can permit new parameters to be easily introduced; (2) the descriptions change dynamically and a radio can identify and interpret new descriptions once they are made available; (3) the descriptions can be provided by multiple domain experts.

In a nonlimiting example, the regulatory policy specifies three unlicensed bands: ISM1 between 900-928 MHz, ISM 2 between 2400-2483.5 MHz, and U-NII bands between 5 and 6 GHz. They can be described using the Manchester OWL syntax as in Table 11.

TABLE 11

```
ISM1 SubClassOf Band and Available and
  (bandwidth some MHz [>=900, <=928]) and
  (maxPower some mW [<=1000])
ISM2 SubClassOf Band and Available and
  (bandwidth some MHz [>=2400, <=2483.5])
  and (maxPower some mW [<=1000])
UNIILow SubClassOf Band and Available and
  (bandwidth some GHz [>=5.15, <=5.25]) and
  (maxPower some mW [<=50]) and
  (use only Indoor)
UNIIMid SubClassOf Band and Available and
  (bandwidth some GHz [>=5.25, <=5.35]) and
  (maxPower some mW [<=250]) and
  (use only (Indoor or Outdoor))
UNII2 SubClassOf Band and Available and
  (bandwidth some GHz [>=5.47, <=5.725]) and
  (maxPower some mW [<=250]) and
  (use only (Indoor or Outdoor))
UNIIHigh SubClassOf Band and Available and
  (bandwidth some GHz [>=5.725, <=5.825]) and
  (maxPower someW [<=1]) and
  (use only Indoor)
```

In some examples, when the CE makes a query about unlicensed bands, there can be multiple answers. Additional queries or reasoning can be invoked to try to improve the decision. Inference is the process of deducing new information. For example, an inference engine can be used. If the location of the RF device can be inferred, then the choices can be narrowed (e.g., based on Indoor vs. Outdoor). Similarly, the CE can infer other parameters such as QoS, user preferences, etc. Furthermore, ontologies may have security levels attached to them. Certain parts of the ontologies could be Secret while certain other parts may be Unclassified. For example, a radio may not be authorized to infer that a certain frequency band is used for a military purpose.

Various examples of CEs can use established semantic web tools while using ontology specifically designed for the wireless realm.

Various aspects herein provide a packet-based RF-digital interface that is independent of any radio protocol. Because the interface is open the RF FPGA or other RF front end can be replaced independently of the digital hardware.

Various aspects herein include a thin radio client or a cognitive radio cloud. Cognitive radio clouds can share resources to achieve economies of scale. Various aspects herein permit readily adding thin radio clients to the cloud. Example cognitive radio clouds as described herein can support, e.g., voice and/or data services with limited QoS or data rate or with enhanced QoS.

Various aspects herein provide or use a cognitive radio ontology, e.g., in operating semantic wireless networks. The ontology can be dynamic and can expand as new radio architectures and solutions are developed.

Example cloud-based architectures described herein can advantageously permit readily analyzing operations of the architecture. The cloud can permit distributed databases to be used to complement a central database. Distributed databases can contain detailed information for smaller geographic areas and can be rapidly or frequently updated to support spectrum sharing.

Various aspects herein relate to an open RF-digital interface, where the RF front end and the digital hardware are replaceable independently of each other. Metadata can be defined to facilitate cognitive radio operation. Various aspects relate to advanced architectures such as SDR clouds.

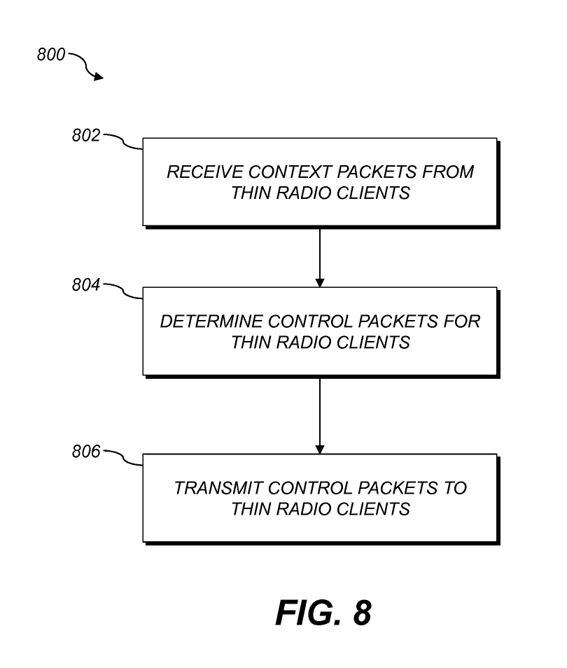

FIG. 8 shows a flowchart 800 illustrating an exemplary method for operating a distributed radio system. The steps can be performed in any order except when otherwise specified, or when data from an earlier step is used in a later step. In at least one example, processing begins with step 802. For clarity of explanation, reference is herein made to various components shown in FIGS. 1-7 that can carry out or participate in the steps of the exemplary method. It should be noted, however, that other components can be used; that is, exemplary method(s) shown in FIG. 8 are not limited to being carried out by the identified components.

At block 802, a processor, e.g., of cloud 114, receives from a plurality of spatially distributed thin radio clients, e.g., spectrum sensors 102 or 108, respective context packets. Each thin radio client includes a radio frequency (RF) subsystem, e.g., as discussed above with reference to FIG. 2, and each context packet includes data based at least in part on the respective RF subsystem. Data in an example context packet is discussed above with reference to Table 3.

At block 804, the processor automatically determines respective control packets for at least some of the thin radio clients. Each control packet includes information to control operations of the respective RF subsystem. Data in an example control packet is discussed above with reference to Table 4.

In some examples, the determining for a selected one of the thin radio clients includes applying stored policy information to at least some of the data in the respective context packet. Example policy information is discussed above with reference to Tables 7 and 11. In some examples, the stored policy information and the at least some of the data include descriptions formed according to an ontology and the applying includes operating an inference engine on the descriptions.

At block 806, the determined control packets are transmitted to the respective ones of the thin radio clients via a packet-based bidirectional interface. This can be, e.g., as discussed above with reference to FIG. 3, 4, or 7.

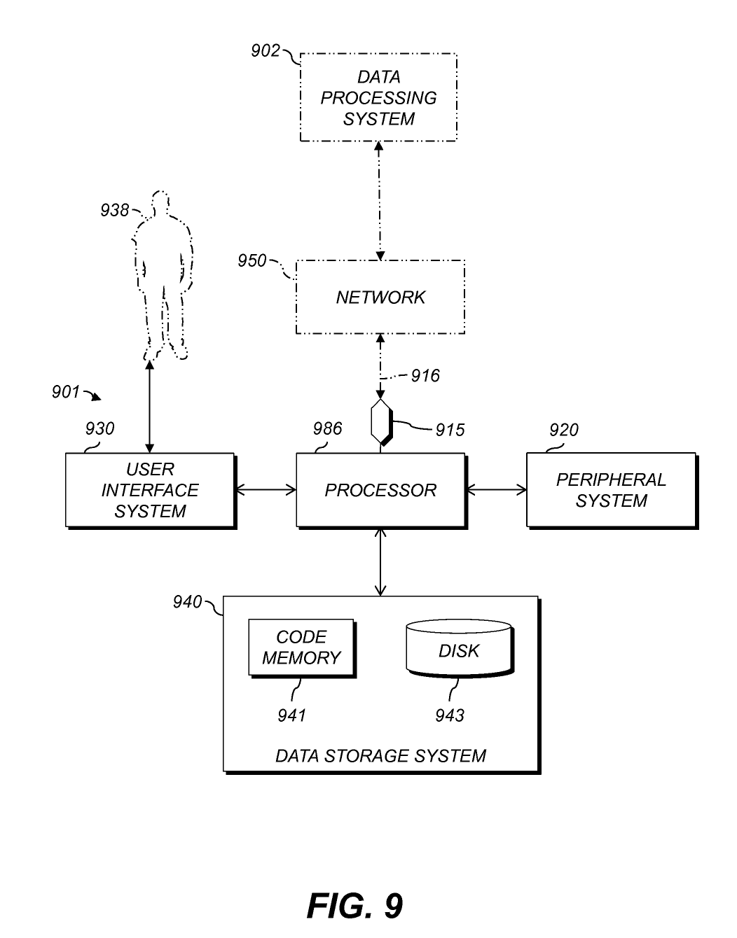

FIG. 9 is a high-level diagram showing the components of an exemplary data-processing system 901 for analyzing data and performing other analyses described herein, and related components. The system 901 includes a processor 986, a peripheral system 920, a user interface system 930, and a data storage system 940. The peripheral system 920, the user interface system 930 and the data storage system 940 are communicatively connected to the processor 986. Processor 986 can be communicatively connected to network 950 (shown in phantom), e.g., the Internet or a leased line, as discussed below. The following can each include one or more of systems 986, 920, 930, 940, and can each connect to one or more network(s) 950: spectrum sensors 102 or 108, cloud 114, ADC/DAC 206, DFE 208, digital hardware 210, user I/O 212, RF-side parser 308, DFE 314, DAC 316, ADC 340, DFE 342, RF-side encoder 332, software control modules 322, 324, 326, 328, 344, 346, or 348, GPS 330, software control module 404, packet interface device 500, ADC 504, local DSP 506, software control modules 508, 510, or 512, digital hardware 602, RFE 604, RFE 702, or RFE 712. Processor 986, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 986 can implement processes of various aspects described herein, e.g., as discussed above with reference to FIG. 8. Processor 986 and related components can, e.g., carry out processes for processing packets, determining control packets based at least in part on context packets, or transmitting or receiving data.

Processor 986 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 920, user interface system 930, and data storage system 940 are shown separately from the data processing system 986 but can be stored completely or partially within the data processing system 986.

The peripheral system 920 can include or be communicatively connected with one or more devices configured or otherwise adapted to provide digital content records to the processor 986 or to take action in response to processor 186. For example, the peripheral system 920 can include digital still cameras, digital video cameras, cellular phones, or other data processors. The processor 986, upon receipt of digital content records from a device in the peripheral system 920, can store such digital content records in the data storage system 940.

The user interface system 930 can convey information in either direction, or in both directions, between a user 938 and the processor 986 or other components of system 901. The user interface system 930 can include a mouse, a keyboard, another computer (connected, e.g., via a network or a null-modem cable), or any device or combination of devices from which data is input to the processor 986. The user interface system 930 also can include a display device, a processor-accessible memory, or any device or combination of devices to which data is output by the processor 986. The user interface system 930 and the data storage system 940 can share a processor-accessible memory.

In various aspects, processor 986 includes or is connected to communication interface 915 that is coupled via network link 916 (shown in phantom) to network 950. For example, communication interface 915 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WIFI or GSM. Communication interface 915 sends and receives electrical, electromagnetic or optical signals that carry digital or analog data streams representing various types of information across network link 916 to network 950. Network link 916 can be connected to network 950 via a switch, gateway, hub, router, or other networking device.

In various aspects, system 901 can communicate, e.g., via network 950, with a data processing system 902, which can include the same types of components as system 901 but is not required to be identical thereto. Systems 901, 902 are communicatively connected via the network 950. Each system 901, 902 executes computer program instructions to, e.g., communicate via a radio system such as discussed above with reference to FIG. 1. In some examples, system 901 is embodied in spectrum sensor 102 and system 902 is embodied in cloud 114. In some examples, system 901 is embodied in spectrum sensor 102 and system 902 is embodied in spectrum sensor 108.

Processor 986 can send messages and receive data, including program code, through network 950, network link 916 and communication interface 915. For example, a server can store requested code for an application program (e.g., a JAVA applet) on a tangible non-volatile computer-readable storage medium to which it is connected. The server can retrieve the code from the medium and transmit it through network 950 to communication interface 915. The received code can be executed by processor 986 as it is received, or stored in data storage system 940 for later execution.

Data storage system 940 can include or be communicatively connected with one or more processor-accessible memories configured or otherwise adapted to store information. The memories can be, e.g., within a chassis or as parts of a distributed system. The phrase “processor-accessible memory” is intended to include any data storage device to or from which processor 986 can transfer data (using appropriate components of peripheral system 920), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 940 can be a tangible non-transitory computer-readable storage medium, i.e., a non-transitory device or article of manufacture that participates in storing instructions that can be provided to processor 986 for execution.

In an example, data storage system 940 includes code memory 941, e.g., a RAM, and disk 943, e.g., a tangible computer-readable rotational storage device or medium such as a hard drive. Computer program instructions are read into code memory 941 from disk 943. Processor 986 then executes one or more sequences of the computer program instructions loaded into code memory 941, as a result performing process steps described herein. In this way, processor 986 carries out a computer implemented process. For example, steps of methods described herein, blocks of the flowchart illustrations or block diagrams herein, and combinations of those, can be implemented by computer program instructions. Code memory 941 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, computer storage media do not include communication media. That is, computer storage media do not include communications media consisting solely of a modulated data signal, a carrier wave, or a propagated signal, per se.

The program code includes computer program instructions that can be loaded into processor 986 (and possibly also other processors), and that, when loaded into processor 986, cause functions, acts, or operational steps of various aspects herein to be performed by processor 986 (or other processor). Computer program code for carrying out operations for various aspects described herein may be written in any combination of one or more programming language(s), and can be loaded from disk 943 into code memory 941 for execution. The program code may execute, e.g., entirely on processor 986, partly on processor 986 and partly on a remote computer connected to network 950, or entirely on the remote computer.

### Example Clauses

A: A thin radio client comprising: a radio frequency front end; and a processing system implementing a packet based bi-directional interface configured to exchange data between a digital back end remote from the thin radio client and the radio frequency front end.

B: The thin radio client of paragraph A, wherein the radio frequency front end includes software defined elements and wherein the interface is further configured to translate contents of control packets specifying settings for at least one of the software defined elements to reconfigure the radio frequency front end.

C: The thin radio client of paragraph A or B, wherein the interface is further configured to generate context packets containing data identifying the thin radio client and to send the context packets to the digital back end.

D: The thin radio client of any of paragraphs A-C, wherein the interface is further configured to detect settings characterizing the front end, to generate context packets containing data describing the settings, and to send the context packets to the digital back end.

E: The thin radio client of any of paragraphs A-D, wherein the interface is further configured to detect capabilities of the thin radio client, to generate context packets containing data describing the capabilities, and to send the context packets to the digital back end.

F: The thin radio client of any of paragraphs A-E, wherein the interface is further configured to generate signal packets containing data representing an RF signal from the front end and to send the signal packets to the digital back end.

G: The thin radio client of any of paragraphs A-F, wherein the interface is further configured to receive signal packets from the digital back end and to generate a stream of digital samples representing data contained in the signal packets for the front end.

H: The thin radio client of any of paragraphs A-G, wherein the interface is further configured to generate extension packets containing data from the front end and to send the extension packets to the digital back end.

I: The thin radio client of any of paragraphs A-H, wherein the front end is configured to detect a spectrum occupancy associated with a location of the thin radio client and wherein the interface is further configured to generate extension packets containing data describing the spectrum occupancy and to send the extension packets to the digital back end.

J: A distributed spectrum-sensing system comprising: a plurality of spatially distributed thin radio clients each including a radio frequency front end and a processing system implementing a packet based bi-directional interface, wherein each of the front ends is configured to detect a spectrum occupancy associated with a location of the front end and to generate packets containing data describing the spectrum occupancy; and a digital back end including a set of distributed digital hardware resources in communication with the packet based bi-directional interfaces and configured to implement at least one service that determines the spectrum occupancy at the locations from the packets.

K: The system of paragraph J, wherein the distributed digital hardware resources are further configured to store a record of the determined spectrum occupancy.

L: The system of paragraph K, wherein the record of the determined spectrum occupancy is stored to cloud-based memory.

M: The system of paragraph K or L, wherein the distributed digital hardware resources include memory and wherein the record of the determined spectrum occupancy is stored in the memory.

N: The system of any of paragraphs J-M, wherein the set of distributed digital hardware resources communicate via a network to form cloud-based digital hardware resources.

O: The system of any of paragraphs J-N, wherein the set of distributed digital hardware resources communicate with the packet based bi-directional interfaces via a network to form a cloud-based radio system

P: A digital back end comprising: a set of distributed digital hardware resources configured to offer an implementation of an Air interface standard to at least one radio frequency device in communication with the digital back end such that the at least one radio frequency device and the digital back end operate as a radio according to the Air interface standard.

Q: The digital back end of paragraph P, wherein the set of distributed digital hardware resources is further configured to offer the implementation of the Air interface standard on an on-demand basis.

R: The digital back end of paragraph P or Q, wherein the at least one radio frequency device is a thin radio client.

S: The digital back end of paragraph R, wherein the set of distributed digital hardware resources is further configured to implement a packet based bi-directional interface programmed to exchange data with the at least one thin radio client.

T: The digital back end of any of paragraphs P-S, wherein the set of distributed digital hardware resources is further configured to implement at least one service that selects operating parameters for the at least one radio frequency device.

U: The digital back end of paragraph T, wherein the operating parameters include radio frequency center frequency, bandwidth, type of Air interface standard or network type.

V: The digital back end of any of paragraphs P-U, wherein the set of distributed digital hardware resources is further configured to implement at least one service that identifies policies governing behavior of the at least one radio frequency device.

W: The digital back end of paragraph V, wherein the at least one service further selects operating parameters for the at least one radio frequency device based on the identified policies.

X: The digital back end of any of paragraphs P-W, wherein the set of distributed digital hardware resources is further configured to implement at least one service that determines time varying spectrum occupancy associated with a geographic location of the at least one radio frequency device.

Y: The digital back end of paragraph X, wherein the at least one service further offers digital characterizations of the time varying spectrum occupancy.

Z: The digital back end of any of paragraphs P-Y, wherein the set of distributed digital hardware resources is reconfigurable upon request.

AA: The digital back end of any of paragraphs P-Z, wherein the set of distributed digital hardware resources communicate via a network to form cloud-based digital hardware resources.

AB: A distributed radio system comprising: a plurality of spatially distributed thin radio clients each including a radio frequency front end and a processing system implementing a packet based bi-directional interface; and a digital back end including a set of distributed digital hardware resources configured to control transceiving operations of the radio frequency front ends via the packet based bi-directional interfaces.

AC: The system of paragraph AB, wherein the set of distributed digital hardware resources is further configured to control relaying operations of the radio frequency front ends via the packet based bi-directional interfaces.

AD: The system of paragraph AB or AC, wherein the set of distributed digital hardware resources communicate via a network to form cloud-based digital hardware resources.

AE: The system of any of paragraphs AB-AD, wherein the set of distributed digital hardware resources communicate with the thin radio clients via a network to form a cloud-based radio system.

AF: A system for integrating monitoring and analyzing of the radio frequency (RF) spectrum, comprising: a plurality of spectrum sensors; and a cloud-based server, coupled to each of the sensors, each sensor connected using a packet-based interface to the cloud.

AG: The system of paragraph AF, configured to provide: a sensing service to the cloud, where said sensing service is an indication of the spectrum usage at a location of a sensor; a feature identification and/or extraction service, based on analysis of the received signal, said feature identification includes identifying modulation type of the signal; a demodulation service, including demodulation of the signal at a specified time instant and duration.

AH: The system of paragraph AF or AG, that offers hardware as a service, “platform as a service” (PaaS), where in addition to hardware, the service includes system-level software, and “spectrum monitoring software as a service”, where the entire hardware and software solution is offered as a service.

AI: The system of any of paragraphs AF-AH, each sensor comprising: a tuner configured to receive RF radiation and generate an intermediate signal; an analog to digital converter (ADC) configured to receive the intermediate signal and convert the intermediate signal to a digital intermediate signal; an encoder block configured to encode the digital intermediate signal; and a controller configured to control the tuner, the ADC, and the encoder block, the encoder block further configured to communicate output encoded data to a cloud server.

AJ: The system of any of paragraphs AF-AI, the encoder block comprising: a compression signal packer encoder, configured to compress and encode the digital intermediate signal according to a predetermined encoding scheme; an extension packet encoder configured to encode computationally intensive data and append to the output encoded data; and a meta packet encoder configured to encode metadata and append to the output encoded data.

AK: The system of paragraph AJ, where metadata is used to represent spectrum policy as well as the results of spectrum monitoring.

AL: The system of paragraph AK, where ontology is used to represent spectrum policy as well as the results of spectrum monitoring.

AM: The system of paragraph AK or AL, where a predefined relationship is used to compare the spectrum policy and the results of spectrum sensing.

AN: The system of paragraph AM, where said predefined relationship is used to identify violations of the spectrum policy.

AO: The system of paragraph AN, where said predefined relationship is used to identify spectrum availability and opportunities for spectrum sharing

AP: A thin radio client comprising: a radio frequency (RF) subsystem configured to be communicatively connectable to an antenna system, the RF subsystem including at least one of an RF transmitter or an RF receiver; and an interface connected to the RF subsystem and configured to transmit and receive packets, wherein the interface includes at least one subsystem selected from the group consisting of: a transmitter-configuration subsystem configured to reconfigure the RF transmitter in response to a received transmitter-control packet; a receiver-configuration subsystem configured to reconfigure the RF receiver in response to a received receiver-control packet; and a reporting subsystem configured to transmit a context packet including both data of a state of the RF transmitter and data of a state of the RF receiver.

AQ: The thin radio client of paragraph AP, wherein the interface is configured to exchange the packets with a computing device remote from the RF subsystem.

AR: The thin radio client of paragraph AP or AQ, wherein the interface is further configured to transmit the context packet containing identification information of the thin radio client.

AS: The thin radio client of any of paragraphs AP-AR, wherein the interface is further configured to detect setting(s) characterizing the RF subsystem and to transmit the context packet containing data describing the detected setting(s), wherein the data of the detected settings includes ontology description(s) of the detected setting(s).

AT: The thin radio client of any of paragraphs AP-AS, wherein the interface is further configured to detect one or more capabilities of the RF subsystem and to transmit the context packet containing data describing the detected one or more capabilities, wherein the data of the detected capabilities includes ontology description(s) of the detected one or more capabilities.

AU: The thin radio client of any of paragraphs AP-AT, wherein the interface is further configured to transmit one or more signal packets containing data representing an RF signal received at the RF receiver.

AV: The thin radio client of any of paragraphs AP-AU, wherein the RF transmitter is further configured to transmit waveforms corresponding to data contained in one or more signal packets received by the interface.

AW: The thin radio client of any of paragraphs AP-AV, further including a processor configured to determine extension data based at least in part on data representing an RF signal received at the RF receiver, wherein the interface is further configured to transmit extension packet(s) containing at least some of the extension data, e.g., data in other than IQ form, e.g., FFT data, or other types of information such as processing results.

AX: The thin radio client of any of paragraphs AP-AW, wherein the RF subsystem is configured to detect a spectrum occupancy associated with a location of the thin radio client and wherein the interface is further configured to transmit extension packets containing data describing the spectrum occupancy.

AY: A digital back end comprising: an interface configured to transmit packets to, and receive packets from, a radio frequency (RF) device, at least some of the received packets including at least information of capabilities of the RF device, state of the RF device, or RF signals detected by the RF device; and digital hardware resources configured to determine a control packet based at least in part on at least one of the received packets and on a policy, e.g., a stored policy, governing behavior of the RF device, and transmit the control packet to the RF device via the interface.

AZ: The digital back end of paragraph AY, wherein the RF device includes a thin radio client having an RF subsystem.

BA: The digital back end of paragraph AY or AZ, wherein the digital hardware resources are further configured to determine the control packet including operating parameters for the RF device.

BB: The digital back end of paragraph BA, wherein the operating parameters include at least radio frequency center frequency, bandwidth, type of air interface standard, or network type.

BC: The digital back end of paragraph BA or BB, wherein the digital hardware resources are further configured to select at least some of the operating parameters for the RF device based on the policy.

BD: The digital back end of any of paragraphs AY-BC, wherein the digital hardware resources are further configured to determine a time varying spectrum occupancy associated with a geographic location of the RF device.

BE: A method of operating a distributed radio system, the method comprising: receiving from a plurality of spatially distributed thin radio clients respective context packets, wherein each thin radio client includes a radio frequency (RF) subsystem and each context packet includes data based at least in part on the respective RF subsystem; automatically determining, using a processor, respective control packets for at least some of the thin radio clients, each control packet including information to control operations of the respective RF subsystem; and transmitting the determined control packets to the respective ones of the thin radio clients via a packet-based bidirectional interface.

BF: The method of paragraph BE, wherein the determining for a selected one of the thin radio clients includes applying stored policy information to at least some of the data in the respective context packet.

BG: The method according to paragraph BF, wherein the stored policy information and the at least some of the data include descriptions formed according to an ontology and the applying includes operating an inference engine on the descriptions.

BH: The method according to any of paragraphs BE-BG, wherein the receiving includes receiving the respective context packets via the packet-based bidirectional interface.

BI: The method according to any of paragraphs BE-BH, wherein at least one of the context packets includes information of one or more states or one or more capabilities of both a transmitter of the respective RF subsystem and a receiver of the respective RF subsystem.

### CONCLUSION

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention. Those skilled in the art will recognize that numerous modifications can be made to the specific implementations described above. The implementations should not be limited to the particular limitations described. Other implementations may be possible.

What is claimed is:

1. A thin radio client comprising:
a radio frequency (RF) subsystem configured to be communicatively connectable to an antenna system, the RF subsystem including at least one of an RF transmitter or an RF receiver; and
an interface connected to the RF subsystem and configured to transmit and receive packets, wherein the interface includes at least one subsystem selected from the group consisting of:
a transmitter-configuration subsystem configured to reconfigure the RF transmitter in response to a received transmitter-control packet;
a receiver-configuration subsystem configured to reconfigure the RF receiver in response to a received receiver-control packet; and
a reporting subsystem configured to transmit a context packet including both data of a state of the RF transmitter and data of a state of the RF receiver.

2. The thin radio client of claim 1, wherein the interface is configured to exchange the packets with a computing device remote from the RF subsystem.

3. The thin radio client of claim 1, wherein the interface is further configured to transmit the context packet containing identification information of the thin radio client.

4. The thin radio client of claim 1, wherein the interface is further configured to detect setting(s) characterizing the RF subsystem and to transmit the context packet containing data describing the detected setting(s), wherein the data of the detected settings includes ontology description(s) of the detected setting(s).

5. The thin radio client of claim 1, wherein the interface is further configured to detect one or more capabilities of the RF subsystem and to transmit the context packet containing data describing the detected one or more capabilities, wherein the data of the detected capabilities includes ontology description(s) of the detected one or more capabilities.

6. The thin radio client of claim 1, wherein the interface is further configured to transmit one or more signal packets containing data representing an RF signal received at the RF receiver.

7. The thin radio client of claim 1, wherein the RF transmitter is further configured to transmit waveforms corresponding to data contained in one or more signal packets received by the interface.

8. The thin radio client of claim 1, further including a processor configured to determine extension data based at least in part on data representing an RF signal received at the RF receiver, wherein the interface is further configured to transmit extension packet(s) containing at least some of the extension data.

9. The thin radio client of claim 1, wherein the RF subsystem is configured to detect a spectrum occupancy associated with a location of the thin radio client and wherein the interface is further configured to transmit extension packets containing data describing the spectrum occupancy.

10. A digital back end comprising:
an interface configured to transmit packets to, and receive packets from, a radio frequency (RF) device, at least some of the received packets including at least information of capabilities of the RF device, state of the RF device, or RF signals detected by the RF device; and
digital hardware resources configured to determine a control packet based at least in part on at least one of the received packets and on a stored policy governing behavior of the RF device, and transmit the control packet to the RF device via the interface.

11. The digital back end of claim 10, wherein the RF device includes a thin radio client having an RF subsystem.

12. The digital back end of claim 10, wherein the digital hardware resources are further configured to determine the control packet including operating parameters for the RF device.

13. The digital back end of claim 12, wherein the operating parameters include at least radio frequency center frequency, bandwidth, type of air interface standard, or network type.

14. The digital back end of claim 12, wherein the digital hardware resources are further configured to select at least some of the operating parameters for the RF device based on the policy.

15. The digital back end of claim 10, wherein the digital hardware resources are further configured to determine a time varying spectrum occupancy associated with a geographic location of the RF device.

16. A method of operating a distributed radio system, the method comprising:
receiving from a plurality of spatially distributed thin radio clients respective context packets, wherein each thin radio client includes a radio frequency (RF) subsystem and each context packet includes data based at least in part on the respective RF subsystem;
automatically determining, using a processor, respective control packets for at least some of the thin radio clients, each control packet including information to control operations of the respective RF subsystem; and
transmitting the determined control packets to the respective ones of the thin radio clients via a packet-based bidirectional interface.

17. The method of claim 16, wherein the determining for a selected one of the thin radio clients includes applying stored policy information to at least some of the data in the respective context packet.

18. The method according to claim 17, wherein the stored policy information and the at least some of the data include descriptions formed according to an ontology and the applying includes operating an inference engine on the descriptions.

19. The method according to claim 16, wherein the receiving includes receiving the respective context packets via the packet-based bidirectional interface.

20. The method according to claim 16, wherein at least one of the context packets includes information of one or more states or one or more capabilities of both a transmitter of the respective RF subsystem and a receiver of the respective RF subsystem.
